(19) United States
(12) Patent Application Publication
(10) Pub. No.: US 2014/0350955 A1
(43) Pub. Date: Nov. 27, 2014

(54) MEDICAL DATA TRANSMISSION AND COLLECTION SYSTEM AND PROCESS

(71) Applicant: MICHAEL YEDIDSION, Los Angeles, CA (US)

(72) Inventor: MICHAEL YEDIDSION, Los Angeles, CA (US)

(21) Appl. No.: 14/283,455

(22) Filed: May 21, 2014

Related U.S. Application Data
(60) Provisional application No. 61/825,711, filed on May 21, 2013.

(51) Int. Cl. G06F 19/00

(52) U.S. Cl. CPC G06F 19/3418
USPC 705/2

(57) ABSTRACT

A system for electronically transferring patient medical data from a medical diagnostic device at a non-medical location to a diagnostic facility for analysis, processing, and publishing for review is disclosed. In some embodiments, the system comprises a set of medical diagnostic devices, a mobile computing device that connects to and receives patient medical data from a medical diagnostic device, a server that receives encrypted patient medical data from the mobile computing device for data processing and publication, and a server for hosting a web site on which the published patient medical data is posted for review by the patient and professionals of the diagnostic facility.

### CLAIM OF BENEFIT TO PRIOR APPLICATION

This application claims benefit to U.S. Provisional Patent Application 61/825,711, entitled “SYSTEM AND METHOD FOR TRANSFERRING MEDICAL DATA OBTAINED FROM A MEDICAL PATIENT AT A NON-MEDICAL LOCATION BY A MEDICAL DEVICE TO A DIAGNOSTIC FACILITY,” filed May 21, 2013. The U.S. Provisional Patent Application 61/825,711 is incorporated herein by reference.

### BACKGROUND

Many patients of medical services use medical or health care devices to obtain vital health information. Normally, patients use such devices at medical facilities. Typically the existing devices used by patients and healthcare professionals to record and save vital health statistics (hereafter referred to as “medical data” or “data”) need to be physically transferred to a diagnostic facility after testing is completed for the data to be accessed.

In some cases, the data obtained from the devices can only be gathered for analysis and review at the diagnostic facility due to hardware or software-based limitations associated with retrieval of the data from the device. Thus, the device generally must be returned to the diagnostic facility regardless of where the medical diagnostic device is used (e.g., at home or at other locations away from the medical facility, or at the medical facility itself) to obtain the patient's medical data. This process leads to delayed availability of testing data, in addition to, increased transaction costs for the retrieval and processing of the patient's medical data.

This is problematic for patients and healthcare providers who would benefit from greater freedom of location at which a patient can obtain medical data using a medical diagnostic device. For example, a particular medical device may be simple enough for a patient to use in any setting (e.g., a saliva sample from patient before the patient eats breakfast and obtained at the patient's home, office, car, etc.). Thus, a medical health care provider may want to preserve medical staffing resources (e.g., nurses and medical technicians) for specific vital procedures or for administering diagnostic tests using complicated and/or complex diagnostic devices.

Thus, what is needed is the ability to obtain a patient's medical data from a medical device that is used at any location (including a home, an office, or any other non-medical location) to accumulate the medical data, and after the patient's medical data is obtained from the device, to transfer the medical data to a location at which the data can be analyzed and reviewed.

### BRIEF SUMMARY

Some embodiments of the invention provide a novel medical data transmission and collection system that electronically transfers patient medical data from a medical diagnostic device used at a non-medical location to obtain the patient medical data to server computing device used to save the patient medical data for analysis, processing, and publishing for review at a diagnostic facility. In some embodiments, the medical data transmission and collection system comprises a set of medical diagnostic devices, a medical data collection and transmission bridge device, a server for data collection, and a server for hosting a web site. In some embodiments, the set of medical diagnostic devices comprise at least one of an oximeter, a blood-glucose monitor, a blood pressure monitor, and a home sleep testing (HST) device. In some embodiments, at least one medical diagnostic device in the set of medical diagnostic devices comprises a Bluetooth communication device that is used by the medical diagnostic device to transmit the patient medical data to the medical data collection and transmission bridge device. In some embodiments, the medical data collection and transmission bridge device comprises a mobile computing device.

Some embodiments include a process for transferring patient medical data from a medical diagnostic device to a diagnostic facility. In some embodiments, the process is performed by the medical data collection and transmission bridge device of the medical data transmission and collection system. In some embodiments, the process for transferring patient medical data comprises (i) receiving a set of medical data from the medical diagnostic device after a patient uses the medical diagnostic device to obtain the medical data, (ii) preparing the received medical data for transmission to a remote server, and (iii) transmitting the medical data to the remote server.

Some embodiments include a process for collecting patient medical data obtained by a medical diagnostic device and transmitted to a server to save in a database for analysis, processing, and publishing for review at a diagnostic facility. In some embodiments, the process is performed by a server of the medical data transmission and collection system. In some embodiments, the process for collecting patient medical data comprises (i) receiving a set of medical data obtained from a patient by use of a medical diagnostic device, (ii) identifying an order associated with the medical diagnostic device, and (iii) saving the set of medical data in a database by reference to the order associated with the medical diagnostic device.

In some embodiments, the medical data transmission and collection system performs an overall process for transferring the patient medical data to the medical data collection and transmission bridge from the medical diagnostic device and from the medical data collection and transmission bridge to a server to store the patient medical data in a database accessible to a diagnostic facility for analysis, processing, and publishing of the patient medical data.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matters can be embodied in other specific forms without departing from the spirit of the subject matters.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a medical data transmission, collection, and publication system in some embodiments.

FIG. 2 conceptually illustrates a bridge process in some embodiments for transferring patient medical data from a medical diagnostic device to a server that is accessible to a diagnostic facility.

FIG. 3 conceptually illustrates a server process for collecting, publishing, and preparing patient medical data in some embodiments.

FIG. 4 conceptually illustrates an overall process performed by one or more computing devices of a medical data transmission system for transmitting, collecting, and publishing patient medical data recorded by a particular medical diagnostic device in some embodiments.

FIG. 5 conceptually illustrates a continuation of the overall process of FIG. 4.

FIG. 6 conceptually illustrates a continuation of the overall process of FIG. 5.

FIG. 7 conceptually illustrates a continuation of the overall process of FIG. 6.

FIG. 8 conceptually illustrates a continuation of the overall process of FIG. 7.

FIG. 9 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several needs.

### I. Medical Data Transmission, Collection, and Publication System

As described above, many existing devices used by patients and healthcare professionals to record and save vital health statistics need to be physically transferred to a diagnostic facility after testing is completed in order to make the data accessible to key medical personnel. The physical movement and transference of such devices prolongs unavailability of the vital health data that is recorded by the devices and simply delays analysis, processing, and/or further testing which may be performed at a diagnostic facility. In practice, delayed availability of vital health information is unfortunate, problematic, and in some cases, may be damaging or life-threatening. Yet, physical transmission of these diagnostic devices is typical.

Some embodiments include a medical data transmission and collection system that electronically transfers patient medical data from a medical diagnostic device used at a non-medical location to obtain the patient medical data to server computing device used to save the patient medical data for analysis, processing, and publishing for review at a diagnostic facility. In some embodiments, the medical data transmission and collection system comprises a set of medical diagnostic devices, a medical data collection and transmission bridge device, a server for data collection, and a server for hosting a web site. In some embodiments, the set of medical diagnostic devices comprise at least one of an oximeter, a blood-glucose monitor, a blood pressure monitor, and a home sleep testing (HST) device. In some embodiments, at least one medical diagnostic device in the set of medical diagnostic devices comprises a Bluetooth communication device that is used by the medical diagnostic device to transmit the patient medical data to the medical data collection and transmission bridge device. In some embodiments, the medical data collection and transmission bridge device comprises a mobile computing device.

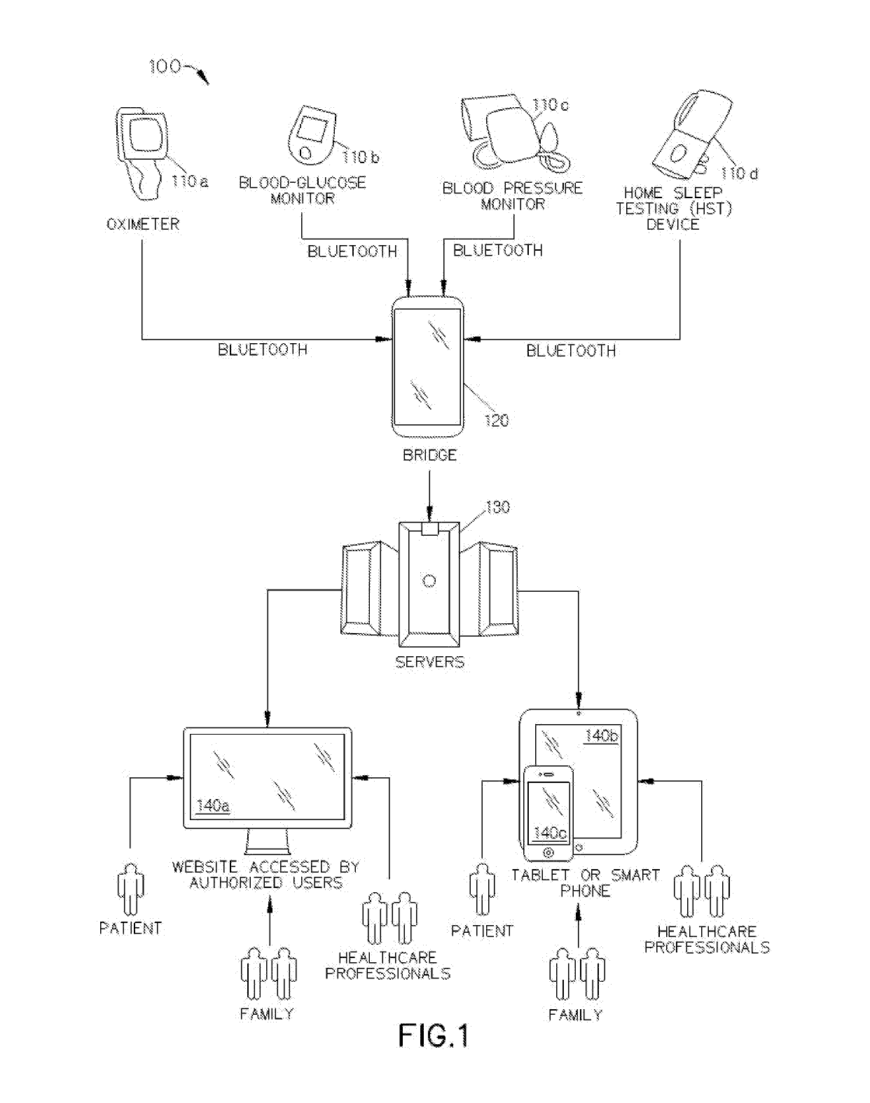

By way of example, FIG. 1 conceptually illustrates a medical data transmission and collection system. As shown in this figure, the medical data transmission and collection system includes a set of medical diagnostic devices 110a-110d. In this example, the medical diagnostic devices include an oximeter 110a, a blood-glucose monitor 110b, a blood pressure monitor 110c, and a home sleep testing device 110d.

Each of the medical diagnostic devices connects to and transmits medical data to a medical data collection and transmission bridge device 120. In some embodiments, the medical data collection and transmission bridge device 120 comprises a hand-held mobile computing device. The bridge device 120 in some embodiments includes a wireless receiver/transmitter. The wireless transmitter/receiver is capable of wireless communication using a wireless communication protocol, such as Bluetooth, WiFi, Edge, 2G, 3G, and 4G. Thus the bridge device 120 is able to transfer data over proprietary wireless networks including Edge, 2G, 3G, and 4G networks of different wireless providers. In the example medical data transmission and collection system 100 shown in FIG. 1, the connection to the medical data collection and transmission bridge device 120 from each medical diagnostic device 110a-110d is a wireless Bluetooth connection.

After the medical data collection and transmission bridge device 120 accumulates all of the patient medical data from an individual medical diagnostic device, transmission of the patient medical data to a server 130 begins. As shown in FIG. 1, the bridge device 120 transmits the data to at least one of the system's servers. In some cases, the servers are housed at diagnostic facilities. In other cases, the servers are physically housed in another location, but are accessible as “cloud servers” over the Internet, or as network servers in a wide area network (WAN), local area network (LAN), or an intranet of a diagnostic facility. Wherever the server may be physically housed, the patient's medical data, once received at the server, is accessible to one or more diagnostic professionals for analysis, review, and publishing of test results. As shown, different interface accessibility options are available to access the testing data. In particular, this example system illustrates a computer 140a for authorized users to access a website with the published results of the patient medical data, a tablet computing device 140b that accesses the testing data, and a smart phone 140c that accesses the patient medical data.

In some embodiments, the bridge device 120 operates on standard mobile device operating systems, including Android and other mobile device operating systems. In addition, the medical data transmission and collection system 100 permits patients and healthcare professionals to connect existing wireless devices to the system 100 as data providers. For instance, instead of using the bridge 120, healthcare professionals may use their existing Bluetooth compatible devices to establish wireless communication with one or more system servers 130. The system is thereby able to collect test data as its being recorded with a diagnostic device and transfer the test data to a server at a diagnostic facility for “Real-Time” processing (i.e., processing contemporaneously with transferring the test data). The results are then posted to a secure website for viewing.

As the illustrated medical data transmission and collection system 100 in FIG. 1 shows, the system differs from and improves upon currently existing systems, processes, and procedures. For instance, the medical data transmission and collection system (i) eliminates costs associated with physical transfer of equipment for the purpose of accessing and/or downloading patient data from the equipment, (ii) accelerates the transfer of data to provide “real time” on-the-fly processing, thus improving reaction times to abnormal health information, and (iii) includes a stand-alone device which can be used with multiple devices at once. Accordingly, the medical data transmission and collection system results in significant improvements over the current options for transferring patient medical data recorded during testing by a medical diagnostic device.

### II. Bridge Process for Transferring Patient Data to a Server

Some embodiments include a bridge process for transferring patient medical data from a medical diagnostic device to a diagnostic facility. In some embodiments, the process is performed by the medical data collection and transmission bridge device of the medical data transmission and collection system. In some embodiments, the process for transferring patient medical data comprises (i) receiving a set of medical data from the medical diagnostic device after a patient uses the medical diagnostic device to obtain the medical test data, (ii) preparing the received medical test data for transmission to a remote server that is accessible to a diagnostic facility, and (iii) transmitting the medical test data to the remote server for analysis and review by trained medical professionals. In some embodiments, the remote server comprises a web server in which the medical test data is posted for review by one or more of trained medical professionals at the diagnostic facility, other professionals and reviewers, and patients.

In some embodiments, the bridge device includes a compatible software application for receiving, processing, and transmitting data to and from one or more remote servers or other computing devices. In some embodiments, the compatible software application connects to and accesses a database storage on the bridge device. In some embodiments, the database storage is an embedded database that temporarily saves medical test data retrieved from one or more medical diagnostic devices. In some embodiments, the saved medical test data is deleted from the database upon successful transmission of the medical test data to the server.

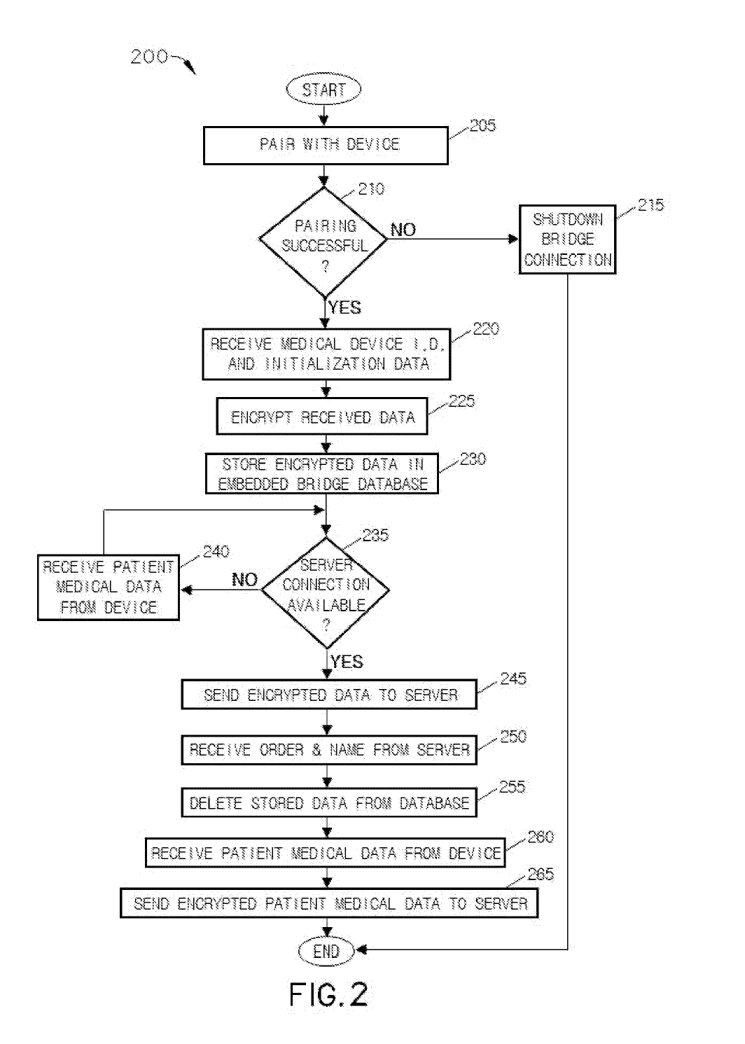

By way of example, FIG. 2 conceptually illustrates a bridge process 200 for transferring patient medical data from a medical diagnostic device to a server that is accessible to a diagnostic facility. The medical data collection and transmission bridge device in some embodiments is preloaded with one or more of the software applications, and therefore, is designed to interface with multiple existing Bluetooth enabled diagnostic devices. The bridge process 200 shown in FIG. 2 is performed by a compatible software application of the medical data collection and transmission bridge device. The bridge process 200 starts when a patient attempts to connect the bridge device to a medical diagnostic device. Because the medical diagnostic devices of the medical data transmission and collection system are able to be used anywhere that is convenient (for example, in a patient's home or at a medical facility), the bridge device must understand which medical diagnostic device will be providing the test data. Therefore, when a patient has a particular device for performing a particular medical diagnostic test, the patient must connect the bridge device to the diagnostic device. The connection can be completed by any compatible form of data communication. For example, the patient may connect the bridge device and diagnostic device via Bluetooth when the bridge device and the diagnostic device are Bluetooth-enabled.

Once a data connection is attempted, the bridge process 200 attempts to pair with the connected medical diagnostic device (at 205). In some embodiments, this initial configuration of a bridge connection requires the patient to input a unique ID # found on each piece of diagnostic equipment into the bridge device using the interactive touch display. In turn, the bridge device will interact with the patient by providing voice commands and by displaying instructions to facilitate pairing and testing.

Next, the bridge process determines (at 210) whether the pairing of the bridge device and the particular medical diagnostic device was successful. If pairing was not successful, the bridge process 200 performs shutdown (at 215) of the bridge connection. Then the bridge process 200 ends. If the pairing was not successful because the patient entered incorrect information, the patient may try to connect the medical diagnostic device to the bridge device again.

On the other hand, if pairing was successful, then the bridge process 200 receives (at 220) the unique ID # of the medical device entered by the patient and any other initialization data associated with the particular medical diagnostic device. The bridge process 200 then encrypts (at 225) the received unique ID # and other data, in preparation of transmission to a server. Before transmitting the encrypted data to the server, however, the bridge process 200 stores (at 230) the encrypted data in the database of the bridge device.

The bridge process 200 then determines (at 235) if a server connection is open/available. If no connection is available, the bridge process receives (at 240) any patient medical data from the particular medical diagnostic device. In some embodiments, the bridge process will continue to collect patient medical data until a server connection is available. However, if the server connection is available (before any of the patient medical data is collected locally by the bridge device), the bridge process 200 will then send (at 245) the encrypted data with the unique ID # to the server. In some embodiments, the bridge process pools/buffers/saves any patient medical data received from the medical diagnostic device while it waits for the server to transmit an order and name associated with the unique ID # of the medical diagnostic device.

Next, the bridge process 200 receives (at 250) the order and name from the server. Depending on the time is takes the server to retrieve the order and name, the time that ensues before the bridge process continues varies. However, the bridge process will collect any data that may be provided by the medical diagnostic device while waiting.

After receiving the order and name from the server, the bridge process 200 deletes (at 255) the stored encrypted data from the local bridge database. If the patient medical data has not already been transmitted, the bridge process 200 next receives (at 260) the patient medical data from the particular medical diagnostic device. Following reception of this data, the bridge process 200 will then send (at 265) encrypted patient medical data to the server. Then the bridge process ends.

As noted above, once the configuration is complete for diagnostic equipment, the bridge device is able to collect data on-the-fly from the diagnostic equipment and transfer the data to the server(s). The servers then collect the data and process it using the software applications. Moreover, the collected data is compiled into various reports which can be accessed by the patient and/or any authorized entity through a dedicated website.

In some embodiments, the transmission path of data is regulated at multiple points. At a first regulation point, a connection to the bridge device from the diagnostic equipment must be authenticated using a unique pairing code. If authentication fails, no link will be made. A connection from the bridge device to the servers is a second point of regulation involving authentication using a 12 digit unique ID. This protocol links the recorded data to an existing user account, but again, if authentication fails, no link will be established.

If each regulated point is successfully authenticated, then the bridge device will begin transmitting data to the servers over the path starting at the diagnostic device, passing to the bridge device, and then out of the bridge device to the server, which subsequently stores the data in a user account of the patient.

Transmission over the path, assuming successful authentication at all regulated points, requires incoming data to the servers be sent by the bridge device in packets at regular intervals over a wireless network. If a connection to the server cannot be established because of a technical failure or insufficient signal strength in the testing area, then the bridge device continues collecting data until a sufficiently strong signal for the wireless connection is established at a later time. Then, the incoming data to the servers is processed through protocol with set parameters which disqualify data deemed “bad” if outside the parameters. Additional protocols prompt the bridge device to retry pairing with a device via Bluetooth after losing its connection and ultimately shutting down in a set amount of time if testing is interrupted or completed.

In some embodiments, an existing android smart phone can be substituted for the bridge device since such phones already are manufactured with Bluetooth, Android OS, interactive display, voice capabilities, and components able to use Edge, 2G, 3G, and 4G data services.

In some embodiments, the Bluetooth and/or data transfer components of the bridge device could be repackaged and physically attached to or installed internally into the diagnostic device that the patient or the facility is using, thus performing the same function but being part of the diagnostic device. In this way, instead of sending each device to a diagnostic facility or performing several complicated steps to get data each time the device is used, the patient or healthcare provider can use the Bridge to simply transfer the data to a website and instantly login to get results and reports from past and present data.

### III. Server Process for Collecting, Publishing, and Preparing Data

Some embodiments include a server process for collecting patient medical data obtained by a medical diagnostic device and transmitted to the server to save in a database for analysis, processing, and publishing for review at a diagnostic facility. In some embodiments, the process is performed by a server of the medical data transmission and collection system. In some embodiments, the server process for collecting patient medical data comprises (i) receiving a set of medical data obtained from a patient by use of a medical diagnostic device, (ii) identifying an order associated with the medical diagnostic device, and (iii) saving the set of medical data in a database by reference to the order associated with the medical diagnostic device.

As described by reference to FIG. 1, the medical data transmission and collection system 100 includes one or more servers 130 for collecting, publishing, and preparing patient medical data for access within the medical data transmission system 100. The server(s) of some embodiments also may post the received and processed data to the web site of the medical data transmission and collection system 100. In this way, users who are registered have access to patient data and can view the processed data at any time. In some embodiments, the server includes a software application to receive, administer, and post data as it's transferred to the server.

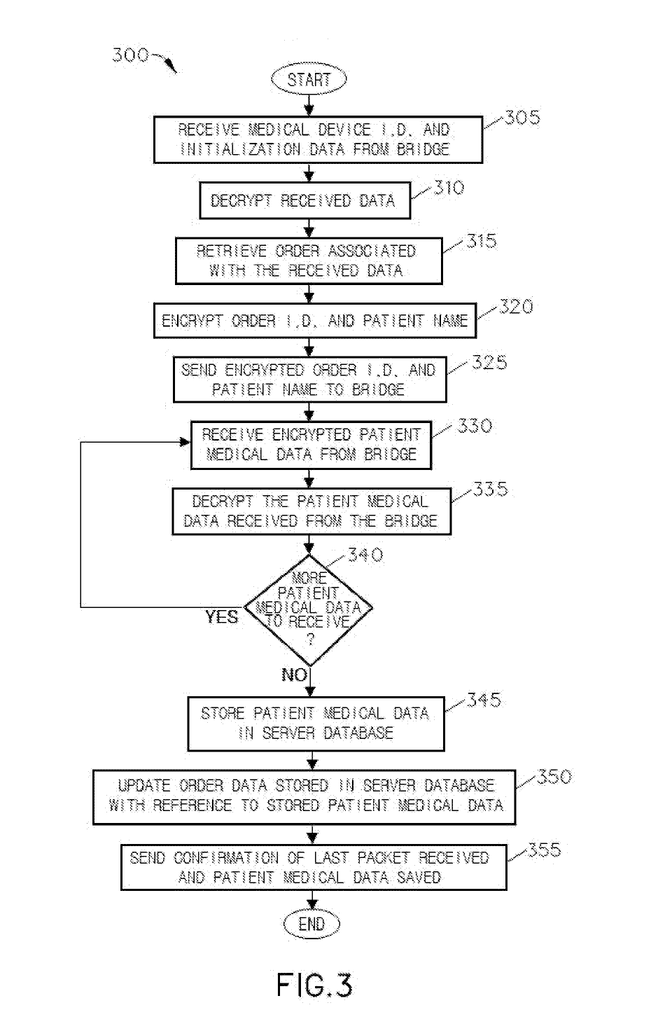

By way of example, FIG. 3 conceptually illustrates a server process 300 for collecting, publishing, and preparing patient medical data for access in a medical data transmission system. In some embodiments, the server process 300 is performed by a server software application to receive, administer, and post the patient medical data.

The server process 300 starts when it receives (at 305) the encrypted unique ID # and initialization data from the bridge device. The server process 300 will then decrypt (at 310) the received data. Once the data is decrypted, the server process 300 then retrieves (at 315) the order that is associated with the unique ID #. The server process 300 next encrypts (at 320) the order ID and patient number which is associated with the unique ID # of the medical diagnostic device. Once encrypted, the server process 300 then sends (at 325) the encrypted order ID and patient name to the bridge device.

This sets the stage for receiving patient test data which was recorded by the medical diagnostic device associated with the unique ID # and which corresponds to the order ID (and the patient's name). Depending on the amount of processing underway in the bridge device, or on the amount of data to be transmitted to the server from the bridge device, the server process 300 may wait for the data to arrive. In some embodiments, the server process locks a session (and any physical server/web server computing device hardware or kernel resources, or operating system functions or resources, used in connection with the session, such as an inbound data port) so that the server process can wait for the patient medical data to arrive from the bridge device. When the patient medical data arrives at the server, the server process 300 then receives (at 330) the encrypted patient medical data that was transmitted by the bridge device. In order to work with the received patient medical data, the server process 300 decrypts (at 335) the patient medical data. In some embodiments, the server process next determines (at 340) whether there is any more patient medical data to receive. In some embodiments, the server process identifies a last data packet in a stream of data packets transmitted by the bridge device and associated with the patient medical data. If the last packet is received, then the server process 300 transitions to storing patient medical data (at 345), which is described in further detail below. On the other hand, if the last packet has not been received, the server process 300 then transitions back to 330 to receive encrypted patient medical data from the bridge. The server process 300 may continue this cycle until the last packet is received for the patient medical data corresponding to the order ID.

In some embodiments, after all of the patient medical data related to the order ID has been received, the server process 300 then stores (at 345) the patient medical data in a database that is accessible to the server process. In some embodiments, the database is a server database with a data storage that is locally accessible on the server computing device. In some embodiments, the database includes a data storage and database management system that runs from a separate computing device accessible to the server computing device.

After storing the patient medical data in the database, the server process 300 in some embodiments updates (at 350) order data that is stored in the data. In some embodiments, the order data is data associated with the order ID, and the server process updates the order data by referencing the patient medical data that was stored in the database at 345. After the data for the order and the patient's test data recorded from the medical diagnostic device and associated with the order ID is saved and updated in the database, the server process 300 in some embodiments sends (at 355) a confirmation to the bridge device that the last packet of data was received and the patient medical data has been saved. Further operations by the server process include publishing the patient medical data and posting the publishing data on a website that is hosted by a web server and accessible to the patient and professionals at one or more diagnostic facilities. Therefore, the server process 300 may end after any one of (i) saving and updating the data in the database (without sending a confirmation to the bridge device), (ii) sending the confirmation to the bridge device, and (iii) publishing the patient medical data for posting on a web server or other formatted medium that is accessible to the patient and professionals at one or more diagnostic facilities.

### IV. Operational Transmission, Collection, and Publication Process

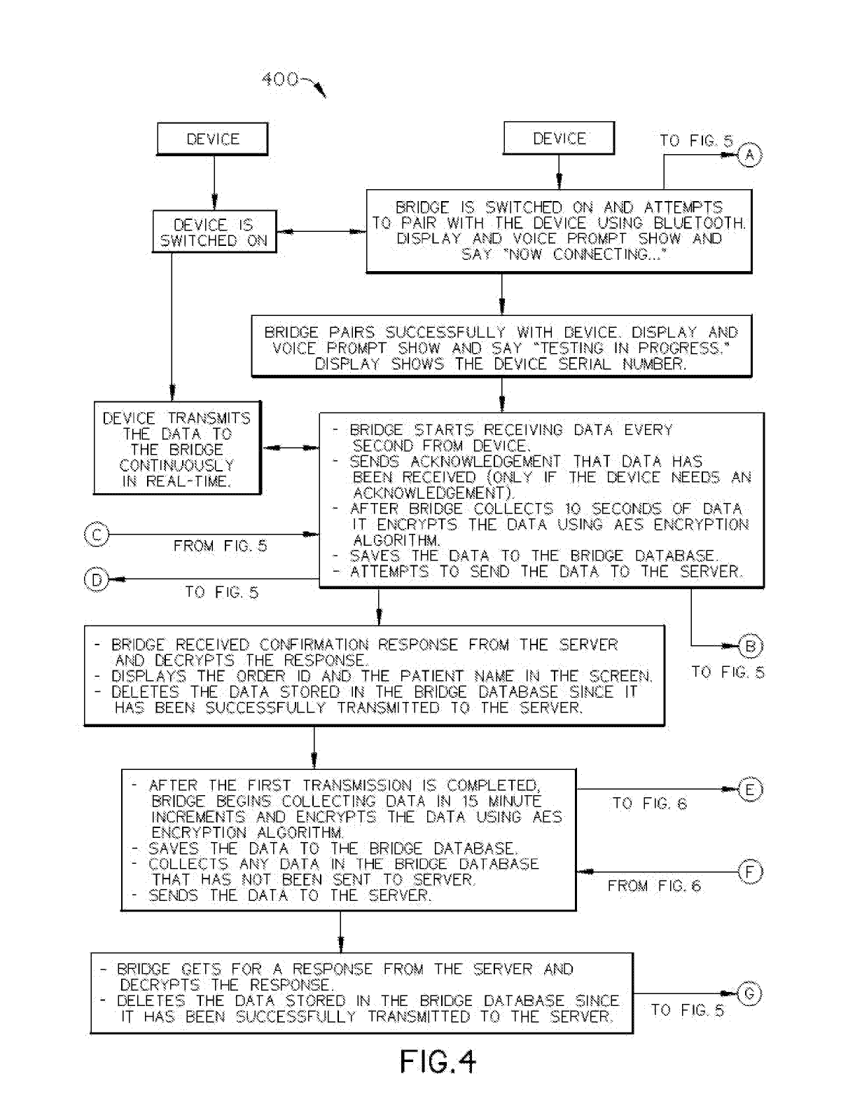

In some embodiments, an overall operational process for transmitting, collecting, and publishing patient medical data recorded by a particular medical diagnostic device is performed by one or more computing devices of the medical data transmission and collection system. By way of example, FIGS. 4-6 conceptually illustrate an overall operational process 400 for transmitting, collecting, and publishing patient medical data recorded by a particular medical diagnostic device.

As shown in FIG. 4, the operational aspects 400 all begin with the medical diagnostic device that a patient (or other person helping the patient) may use to record medical diagnostic test data. For example, a patient using an oximeter may use the device to record blood oxygen level of the patient. The medical diagnostic device, while conceivably operational without a pairing to a bridge device of the system, is not fully operational in practice until it is paired with a bridge device. As shown, the bridge device then receives data (when and if pairing is successful).

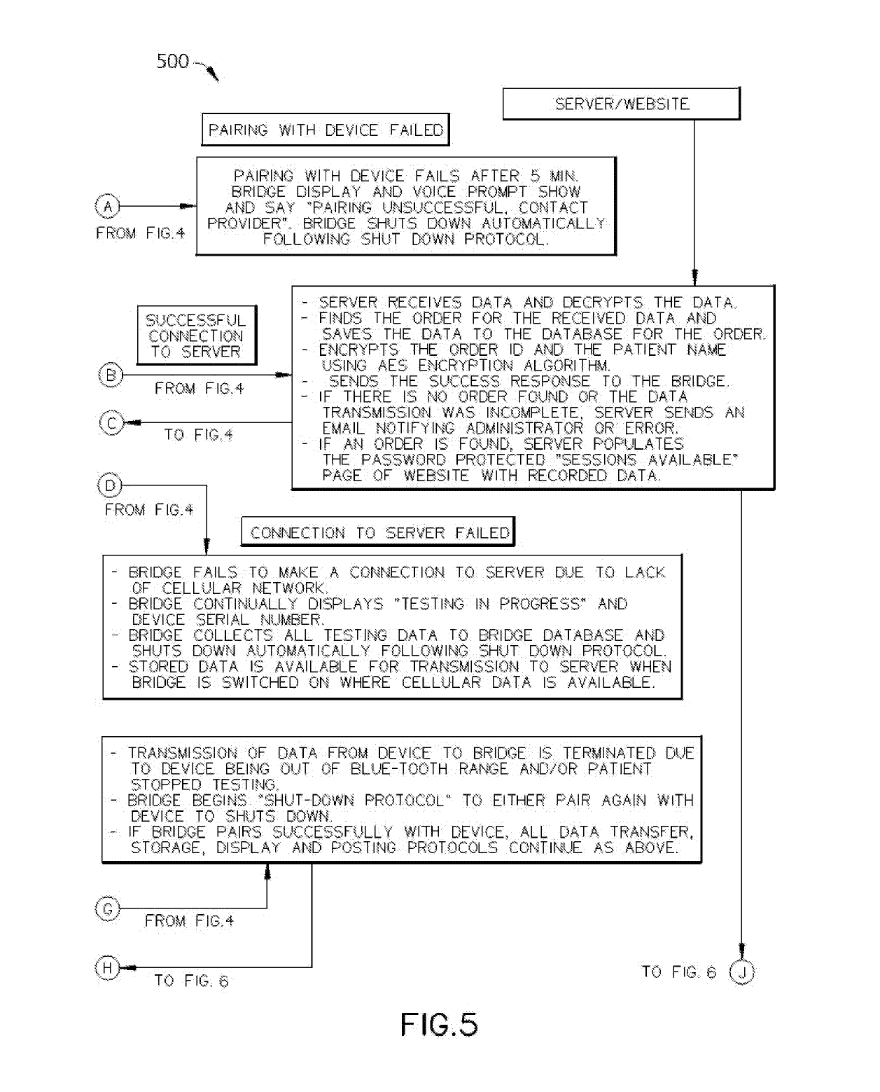

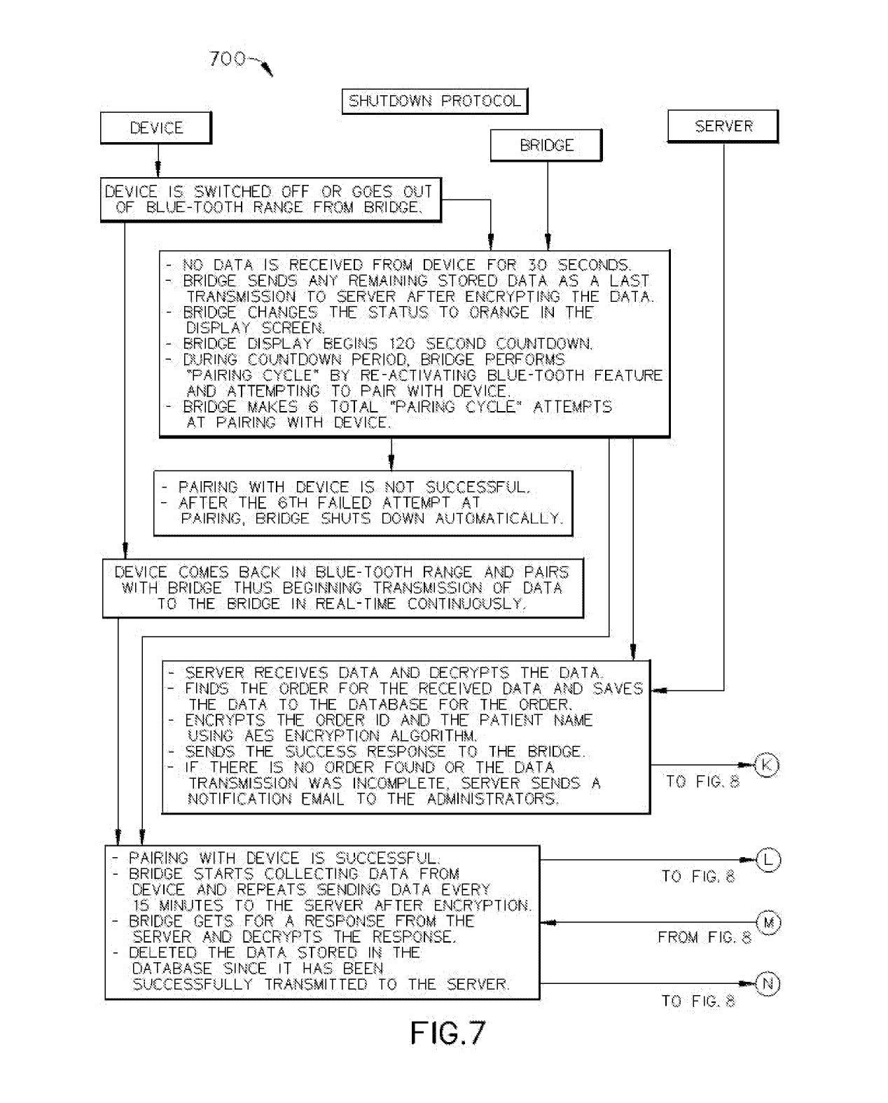

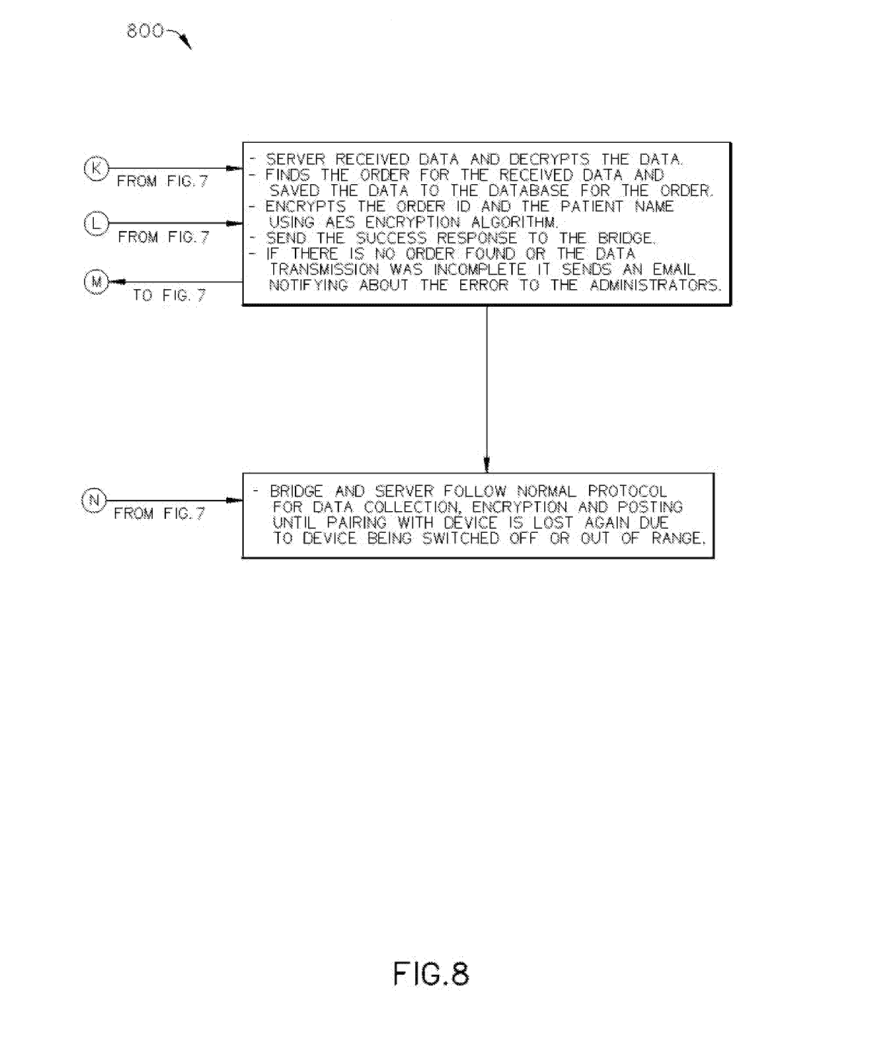

As shown in FIG. 5, however, fail-safe aspects 500 demonstrate that if pairing of the medical diagnostic device and the bridge device fail (i.e., no connection, or timeout occurs), then a shutdown process may ensue. An example of a shutdown process 700 and 800 is described below by reference to FIGS. 7-8.

In addition to details and aspects of the operations that occur with respect to a failure of the bridge device and medical diagnostic device to pair with each other, other details are described in FIG. 5 with respect to a failure of the bridge device in connecting with a server in the system. When this occurs, the bridge device may shutdown and be restarted.

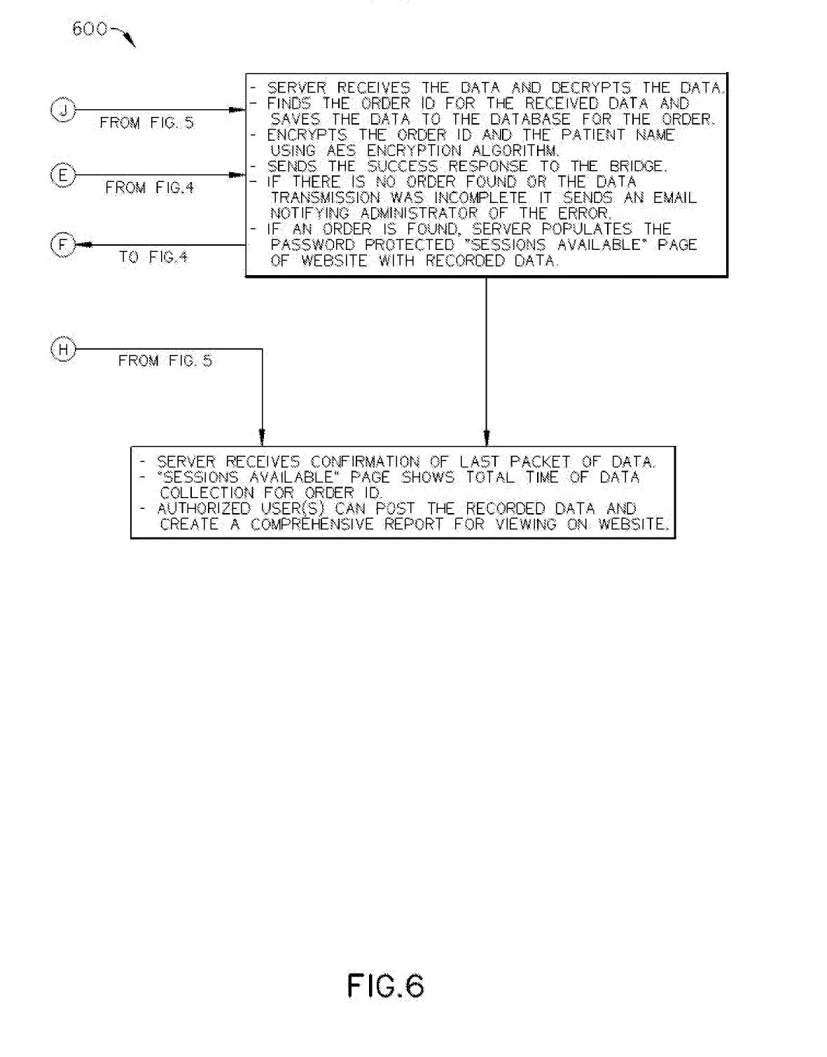

When the bridge device makes a data connection to the server, however, patient medical data transmission, storage, and publication for review occur, as shown by publication-related aspects 600 described in FIG. 6. As shown in this figure, the operations of the medical diagnostic device, the bridge device, and the server may result in a final publication of the patient medical data.

### V. Overall Shutdown Process

In some embodiments, an overall shutdown process is performed by the medical data transmission and collection system when one or more system components/elements is unable to connect or operate in conjunction with other components/elements of the system. By way of example, FIGS. 7-8 conceptually illustrate an overall shutdown process 700 for shutting down one or more system components/elements.

As shown in FIG. 7, each of device components of the system (i.e., the particular medical diagnostic device, the bridge device, and the server computing device) include shutdown or fail-safe operational aspects. For instance, the medical diagnostic device will shutdown if the device is unable to pair with the bridge device. On the other hand, the bridge device will begin fail-safe operations when data is not received for a certain amount of time, and may try several times to “re-pair” with a particular medical diagnostic device when the bridge device is no longer receiving data from the device. The server, on the other hand, does not shutdown or attempt to re-pair. Instead, when a problem is detected, the server automatically generates and sends a notification to an administrator of the system to correct the issue.

In this way, the medical data transmission and collection system is an automated system that allows operation with fail-safe shutdown and remedial procedures to occur with problems are detected. Thus, the risks of losing, altering, damaging, etc., patient medical data and diagnostic test data posting are reduced by the fail-safe and remedial actions of the system, thereby ensuring data consistency and conformity, as well as maintaining patient privacy, etc.

### VI. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors), they cause the processing unit(s) to perform the actions indicated in the instructions. Examples of computer readable media include, but are not limited to, CD-ROMs, flash drives, RAM chips, hard drives, EPROMs, EEPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

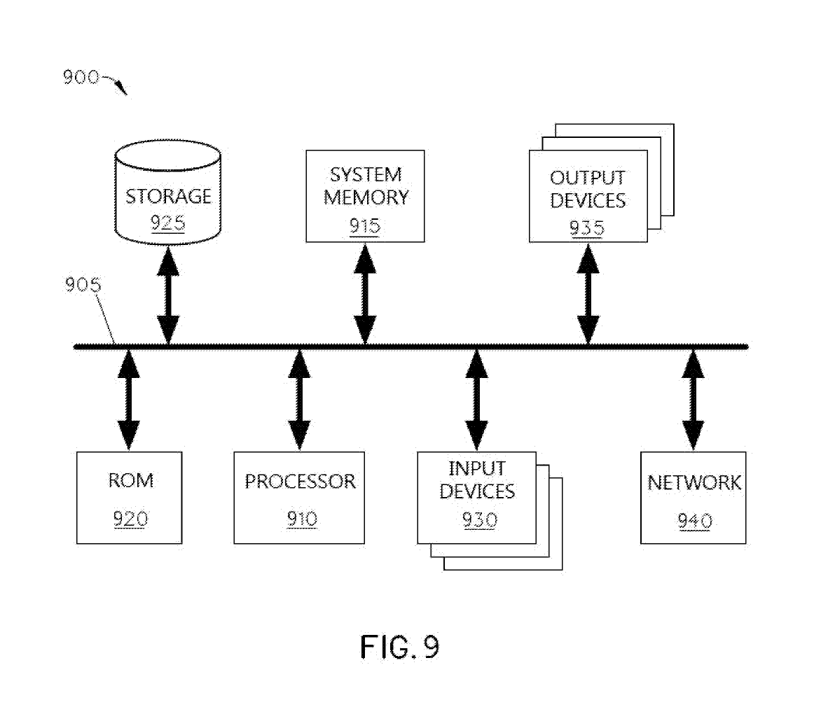

FIG. 9 conceptually illustrates an electronic system 900 with which some embodiments of the invention are implemented. The electronic system 900 may be a computer, phone, PDA, or any other sort of electronic device. Such an electronic system includes various types of computer readable media and interfaces for various other types of computer readable media. Electronic system 900 includes a bus 905, processing unit(s) 910, a system memory 915, a read-only 920, a permanent storage device 925, input devices 930, output devices 935, and a network 940.

The bus 905 collectively represents all system, peripheral, and chipset buses that communicatively connect the numerous internal devices of the electronic system 900. For instance, the bus 905 communicatively connects the processing unit(s) 910 with the read-only 920, the system memory 915, and the permanent storage device 925.

From these various memory units, the processing unit(s) 910 retrieves instructions to execute and data to process in order to execute the processes of the invention. The processing unit(s) may be a single processor or a multi-core processor in different embodiments.

The read-only-memory (ROM) 920 stores static data and instructions that are needed by the processing unit(s) 910 and other modules of the electronic system. The permanent storage device 925, on the other hand, is a read-and-write memory device. This device is a non-volatile memory unit that stores instructions and data even when the electronic system 900 is off. Some embodiments of the invention use a mass-storage device (such as a magnetic or optical disk and its corresponding disk drive) as the permanent storage device 925.

Other embodiments use a removable storage device (such as a floppy disk or a flash drive) as the permanent storage device 925. Like the permanent storage device 925, the system memory 915 is a read-and-write memory device. However, unlike storage device 925, the system memory 915 is a volatile read-and-write memory, such as a random access memory. The system memory 915 stores some of the instructions and data that the processor needs at runtime. In some embodiments, the invention's processes are stored in the system memory 915, the permanent storage device 925, and/or the read-only 920. For example, the various memory units include instructions for processing appearance alterations of displayable characters in accordance with some embodiments. From these various memory units, the processing unit(s) 910 retrieves instructions to execute and data to process in order to execute the processes of some embodiments.

The bus 905 also connects to the input and output devices 930 and 935. The input devices enable the user to communicate information and select commands to the electronic system. The input devices 930 include alphanumeric keyboards and pointing devices (also called “cursor control devices”). The output devices 935 display images generated by the electronic system 900. The output devices 935 include printers and display devices, such as cathode ray tubes (CRT) or liquid crystal displays (LCD). Some embodiments include devices such as a touchscreen that functions as both input and output devices.

Finally, as shown in FIG. 9, bus 905 also couples electronic system 900 to a network 940 through a network adapter (not shown). In this manner, the computer can be a part of a network of computers (such as a local area network (“LAN”), a wide area network (“WAN”), or an Intranet), or a network of networks (such as the Internet). Any or all components of electronic system 900 may be used in conjunction with the invention.

The functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For example, processes are conceptually illustrated in FIGS. 2-8. The specific operations of these processes may not be performed in the exact order shown and described. Specific operations may not be performed in one continuous series of operations, and different specific operations may be performed in different embodiments. Furthermore, the processes could be implemented using several sub-processes, or as part of larger macro processes. Thus, one of ordinary skill in the art would understand that the invention is not to be limited by the foregoing illustrative details and examples, but rather is to be defined by the appended claims.

I claim:

1. A system that electronically transfers patient medical data to a diagnostic facility for review, the system comprising:
a medical diagnostic device that records patient medical data according to a diagnostic operation the medical diagnostic device is configured to perform when used by a patient;
a bridge device comprising a processor, a memory unit, a data storage device, and a transceiver capable of wireless communication to connect to and pair with the medical diagnostic device;
a software application compatible with the bridge device for receiving data from the medical diagnostic device, processing the received data, and transmitting the processed data to one or more remote servers;
a server computing device that receives the processed data transmitted by the software application compatible with the bridge device, said server computing device comprising a processing unit, a memory, and a data storage device;
a website that hosts published patient medical data for professionals associated with the diagnostic facility to review; and
a software application for receiving, administering, and posting data in real time as the data is transferred to the server.

2. The system of claim 1, wherein the medical diagnostic device is one of an oximeter, a blood-glucose monitor, a blood pressure monitor, and a home sleep testing device.

3. The system of claim 1, wherein the wireless communication comprises Bluetooth wireless communication to connect to and pair with the medical diagnostic device.

4. The system of claim 1, wherein the bridge device is a hand-held mobile computing device.

5. The system of claim 1, wherein said processing the received data by the software application compatible with the bridge device comprises encrypting the received data.

6. The system of claim 5, wherein said encrypting the received data comprises encrypting the received data by AES encryption.

7. The system of claim 5, wherein said encrypted data received by the server from the bridge device is decrypted by the server software application.

8. A non-transitory computer readable medium storing a program which, when executed by at least one processing unit of a computing device, transfers patient medical data from a medical diagnostic device to a server that is accessible to a diagnostic facility, said program comprising sets of instructions for:
pairing with the medical diagnostic device;
receiving, from the medical diagnostic device, a set of patient medical data recorded by the medical diagnostic device when the medical diagnostic device was used in connection with a particular patient;
encrypting the received set of patient medical data; and
transmitting the encrypted set of patient medical data to the server for publication on a website that is accessible to professionals of the diagnostic facility.

9. The non-transitory computer readable medium of claim 8, wherein the set of instructions for pairing with the medical diagnostic device comprise sets of instructions for:
connecting wirelessly to the medical diagnostic device; and
receiving an identification of the medical diagnostic device.

10. The non-transitory computer readable medium of claim 8, wherein the program further comprises a set of instructions for storing the encrypted set of patient medical data in a database before transmitting the encrypted set of patient medical data to the server.

11. The non-transitory computer readable medium of claim 10, wherein the program further comprises a set of instructions for receiving an order ID and patient name from the server.

12. The non-transitory computer readable medium of claim 11, wherein the program further comprises a set of instructions for deleting the stored encrypted set of patient medical data from the database after receiving the order ID and the patient name from the server.
